(19) United States
(12) Patent Application Publication
(10) Pub. No.: US 2025/0158239 A1
(43) Pub. Date: May 15, 2025

(54) Battery Module

(71) Applicant: SAMSUNG SDI CO., LTD., Yongin-si (KR)

(72) Inventors: Ilya GOMBATS, Graz (AT); Lukas WALTER, Graz (AT)

(21) Appl. No.: 18/770,503

(22) Filed: Jul. 11, 2024

(30) Foreign Application Priority Data
Nov. 15, 2023 (EP) 23210137.8

(51) Int. Cl. H01M 50/519; H01M 10/42; H01M 50/204; H01M 50/503

(52) U.S. Cl. CPC H01M 50/519; H01M 10/425; H01M 50/204; H01M 50/503; H01M 2010/4271; H01M 2220/20

(57) ABSTRACT

A battery module includes: a plurality of battery cells; a busbar electrically connecting the battery cells to each other; a flexible interconnect configured to provide electrical information of the battery cells to a battery management system; and a conductive pad between the flexible interconnect and the busbar. The conductive pad includes: a first part extending in a first plane; a second part extending in a second plane parallel to the first plane and spaced apart from the first part in a direction perpendicular to the first and second planes; and a third part connecting the first part and second part. The first part extends from the third part in a direction opposite the direction the second part extends from the third part. The busbar is attached to the first part of the conductive pad, and the flexible interconnect is attached to the second part of the conductive pad.

### CROSS-REFERENCE TO RELATED APPLICATION

This application claims priority to and the benefit of European Patent Application Ser. No. 23/210,137.8, filed on Nov. 15, 2023, in the European Patent Office, the entire disclosure of which is incorporated herein by reference.

### BACKGROUND

### 1. Field

Aspects of embodiments of the present disclosure relate to a battery module.

### 2. Description of Related Art

Recently, vehicles (e.g., vehicles for transportation of goods and people) have been developed that use electric power as a source for motion. Such an electric vehicle is an automobile that is propelled by an electric motor using energy stored in rechargeable (or secondary) batteries. An electric vehicle may be solely powered by batteries or may be a hybrid vehicle powered by, for example, a gasoline generator (e.g., the vehicle may include a combination of electric motor and a conventional combustion engine). Generally, an electric-vehicle battery (EVB) (or traction battery) is a battery used to power the propulsion of a battery electric vehicle (BEV). Electric-vehicle batteries differ from starting, lighting, and ignition batteries in that they are designed to provide (or output) power over sustained periods of time. A rechargeable (or secondary) battery differs from a primary battery in that it is designed to be repeatedly charged and discharged, while the latter provides an irreversible conversion of chemical to electrical energy. Low-capacity rechargeable batteries may be used as a power supply for small electronic devices, such as cellular phones, notebook computers, and camcorders, while high-capacity rechargeable batteries may be used as a power supply for hybrid vehicles and the like.

Generally, rechargeable batteries include an electrode assembly including a positive electrode, a negative electrode, and a separator interposed between the positive and negative electrodes, a case receiving (or accommodating) the electrode assembly, and an electrode terminal electrically connected to the electrode assembly. An electrolyte solution is injected into the case to enable charging and discharging of the battery via an electrochemical reaction between the positive electrode, the negative electrode, and the electrolyte solution. The shape of the case, such as a cylindrical or rectangular shape, may be varied based on the battery's intended purpose. Lithium-ion (and similar lithium polymer) batteries, widely known via their use in laptops and consumer electronics, are the most common type of battery powering the most recent electric vehicles in development.

Rechargeable batteries may be used as (e.g., may be a part of) a battery module including (or formed of) a plurality of unit battery cells coupled to each other in series and/or in parallel to provide high energy density, such as for motor driving of a hybrid vehicle. For example, the battery module may be formed by interconnecting the electrode terminals of the plurality of unit battery cells to each other, the number of unit battery cells depending on a desired amount of power, to realize a high-power rechargeable battery.

Battery modules can be constructed in either a block design or a modular design. In the block design, each battery is coupled to a common current collector structure and a common battery management system, and the unit thereof is arranged in a housing. In the modular design, pluralities of battery cells are connected to form submodules, and several submodules are connected to form the battery module. In automotive applications, battery systems often consist of a plurality of battery modules connected to each other in series to provide a desired voltage. The battery modules may include submodules with a plurality of stacked battery cells, and each stack may include cells connected in parallel that are, in turn, connected in series (XpYs) or cells connected in series that are, in turn, connected in parallel (XsYp).

A battery pack is a set of any number of (often identical) battery modules. They may be configured in a series, parallel or a mixture of both to deliver the desired voltage, capacity, or power density. Battery packs include the individual battery modules and the interconnects, which provide electrical conductivity between them.

A battery system may include a battery management system (BMS), which is a suitable electronic system configured to manage the rechargeable battery, battery module, and battery pack, such as by protecting the rechargeable batteries from operating outside their safe operating area, monitoring their states, calculating secondary data, reporting that data, controlling their environment, authenticating them, and/or balancing them. For example, the BMS may monitor the state of the rechargeable battery as represented by voltage (e.g., total voltage of the battery pack or battery modules and/or voltages of individual cells), temperature (e.g., an average temperature of the battery pack or battery modules, coolant intake temperature, coolant output temperature, and/or temperatures of individual cells), coolant flow (e.g., flow rate and/or cooling liquid pressure), and current. Additionally, the BMS may calculate values based on the above parameters, such as minimum and maximum cell voltage, state of charge (SOC) or depth of discharge (DOD) to indicate the charge level of the battery, state of health (SOH; a variously-defined measurement of the remaining capacity of the battery as % of the original capacity), state of power (SOP; the amount of power available for a defined time interval given the current power usage, temperature, and other conditions), state of safety (SOS), maximum charge current as a charge current limit (CCL), maximum discharge current as a discharge current limit (DCL), and internal impedance of a cell (e.g., to determine open circuit voltage).

The BMS may be centralized such that a single controller is connected to the battery cells through a multitude of wires. In other cases, the BMS may be distributed, with a BMS board installed at each cell and only a single communication cable between the battery and a controller. In other cases, the BMS may have a modular construction including a few controllers, each handling a certain number of (e.g., a group of) cells while communicating between the controllers. Centralized BMSs are most economical but are least expandable and are plagued by requiring a multitude of wires. Distributed BMSs are the most expensive but are simplest to install and offer the cleanest assembly. Modular BMSs provide a compromise of the features and drawbacks of the other two topologies.

The BMS may protect the battery pack from operating outside its safe operating area. Operation outside the safe operating area may be indicated by over-current, over-voltage (e.g., during charging), over-temperature, under-temperature, over-pressure, and ground fault or leakage current detection. The BMS may prevent operation outside the battery's safe operating area by including an internal switch (e.g., a relay or solid-state device) which opens if the battery is operated outside its safe operating area, by requesting the devices to which the battery is connected to reduce or even terminate using the battery, and/or by actively controlling the environment, such as through heaters, fans, air conditioning, or liquid cooling.

Static control of battery power output and charging may not be sufficient to meet the dynamic power demands of various electrical consumers connected to the battery system. Thus, steady exchange of information between the battery system and the controllers of the electrical consumers may be employed. This information may include the battery system's actual state of charge (SoC), potential electrical performance, charging ability and internal resistance as well as actual or predicted power demands or surpluses of the consumers. Therefore, battery systems may include a battery management system (BMS) for obtaining and processing such information on a system level and may also include a plurality of battery module managers (BMMs), which are part of the system's battery modules and obtain and process relevant information on a module level. The BMS measures the system voltage, the system current, the local temperature at different places inside the system housing, and the insulation resistance between live components and the system housing, and the BMMs may measure the individual cell voltages and temperatures of the battery cells in a battery module.

The BMS/BMM, also referred to as a battery management unit (BMU), manages the battery pack, such as by protecting the battery from operating outside its safe operating area (or safe operating parameters), monitoring its state, calculating secondary data, reporting that data, controlling its environment, authenticating it and/or balancing it.

To manage or control the battery cells in the battery module or pack, several types of interconnects are utilized. A first type of interconnect is so-called busbars, which connect two or more terminals of battery cells to provide a parallel or serial configuration of the cells. Due to their nature of providing current from/to the cells, busbars are solid and suitable for conducting high currents. Busbars may have a stripe-like shape with a large surface area. The large surface area can carry substantial electric currents. In most applications, busbars are passive components and can be fitted in even very small and cramped installation spaces but, in some cases, they may be active components.

A second type of interconnect relates to signal lines or wires, which are used to transfer electrical information of a cell or sub-module to the BMS/BMU. Due to their nature of carrying signals, those lines may be flexible (e.g., may be implemented as a flexible interconnect, such as a flexible printed circuit (FPC)). Flexible interconnects are used inside the battery module to connect battery cell poles with the battery management unit. The flexible interconnect may extend over the busbars and, in this case, the busbars should have very smooth edges and surfaces, which is difficult to realize and check. A flexible interconnect may be formed as a stack of an isolating (or insulating) base material, a copper layer out of which multiple conducting traces or signal lines may be formed, and an isolating cover layer. The material of the base and the cover layer may relatively very good isolating properties may sufficiently isolate the signal lines while being relatively thin, such as in a range in the tens of micrometers. This isolating cover layer may be a thin layer of an insulating material, such as polyimide (PI), which is mechanically durable. Even though the insulating material is durable from a mechanical point of view, because of its small thickness, it needs to be protected from hazards, such as sharp edges, rough surfaces, stress, and so on. In other words, this durability is limited by the thickness of the layer; in other words, a very thin layer having a single digit micrometer thickness is fragile. Due to the desire to monitor the cell terminals and the generally high number of cells, the flexible interconnect may have a relatively high number of conducting traces, and each trace is connected to a cell terminal or a busbar. In some cases, a cell terminal may be connected to a busbar, which causes it to have the same potential for all connected cell terminals. In this sense, the flexible interconnect may be connected to the busbars to obtain the potential for the cell terminals. If all potentials of all cell terminals are known, the voltage of each cell is known too.

In some cases, busbars may be welded to battery terminals. For example, a welding joint may be formed on a busbar, and a burr can be formed from punching. In particular, welding may leave a welding spot, which may be of considerable height and/or which may have sharp gratings (e.g., a sharp outer surface). Additionally, the busbar may itself have scratches or gratings or a bur from its production process. In combination with movement from cell swelling and vibration of the vehicle, the isolation of the flexible interconnect can be damaged. Hereinafter, all of the preceding matters will be referred to as defects. Although such defects can be removed, this would require additional effort and, thus, is costly. As mentioned above, the flexible interconnects are connected to the busbars.

In the related art, the flexible interconnects have been connected to the busbars by so called pads or tabs, which are a flat piece of sheet metal, often made of nickel (Ni), and which are welded to the busbar, which might be another source of welding defects. Because the Ni-tabs are flat and directly soldered to the flexible interconnect, the flexible interconnect lies directly on the bus bar, which creates a risk of shortcuts (or short circuits) because the flexible interconnect insulation may be only about 50 μm thick polyimide (PI). In other words, when a flexible interconnect lies flat on a busbar—with the flat pad in between—the thin isolation layer of the flexible interconnect may be damaged by one of the above-mentioned defects. Should this be the case, when the busbar is under voltage and the flexible interconnect is connected to other busbars, the risk of a short circuit between them exists. Because the flexible interconnect can be soldered to the pad with the face carrying the signal lines facing downwardly, it may be difficult to check for such short circuits. Additionally, any defects would be covered by the flexible interconnect so that it is difficult to visually inspect the connections for defects. This uncertainty adversely affects reliability of the whole battery module or pack. Furthermore, due to the above difficulties, automatic assembly has been avoided and often manual assembly has been preferred.

Even though busbar-like structures have been used with spacers between it and a flexible interconnect, the spacing provided by the spacer in vertical direction of the flexible PCB is not limited. For example, an additional spacer or positioning member may be necessary to position the flexible PCB at a desired height. Further, a blade of the spacer may go through the flexible PCB, which might not be desired due to complex positioning and the need for holes in the flexible PCB.

In other cases, plastic parts have been used to space the flexible interconnect from the busbar. However, this approach requires additional parts, which is costly due to the additional material and parts required and causes a rather difficult assembly due to the increased number of parts to be assembled and, therefore, leads to increased costs.

### SUMMARY

Embodiments of the present disclosure provide a more reliable battery cell contact structure that can improve automatic assembly of a battery module by providing a distance between the busbar and the flexible interconnect to space the busbar apart from the flexible interconnect. Such a distance can be formed by using a non-flat pad, for instance a non-flat pad made of sheet metal, such as but not limited to Ni-Tabs, which can keep the flexible interconnect away from the busbar to increase the reliability of the interconnect. Embodiments of the present disclosure also provide improved isolation of the interconnect, which leads to a lower risk of short circuits and increased flexibility of the overall interconnect. This flexibility of the interconnect-structure results in improved long-term reliability due to improved stress absorption and release capabilities.

The present disclosure is defined by the appended claims and their equivalents. The description that follows is subject to this limitation, and any disclosure lying outside the scope of the claims and their equivalents is intended for illustrative as well as comparative purposes.

According to an embodiment of the present disclosure, a battery module includes a plurality of battery cells, a busbar electrically connecting the battery cells to each other, a flexible interconnect for providing electrical information of the battery cells to a battery management system, and a conductive pad between the flexible interconnect and the busbar. The conductive pad includes: a first part extending in a first plane, at least one second part extending in a second plane parallel to the first plane and spaced apart from the first part in a direction perpendicular to the first and second planes, and at least one third part connecting the first part with each of the at least one second part. The first part extends from the third part in a direction opposite the direction the second part extends from the third part. The busbar is attached to the first part of the pad, and the flexible interconnect is attached to the second part of the pad.

When the first part and the second part are spaced apart (e.g., vertically spaced apart), a space is formed between the flexible interconnect and the busbar. This space increases reliability of, for example, the flexible interconnect by avoiding damage to the flexible interconnect due to sharp edges, rough surfaces, or burrs on or from the busbar. For example, the risk of a mechanical direct connection between the flexible interconnect, which may be in the form of an FPC, and a busbar resulting in possible cell short circuits is reduced or minimized. Furthermore, the shape of the pad allows deformation if longitudinal stress is applied to the flexible interconnect and reduces the risk of damaging the flexible interconnect, that is, it provides flexibility to the connection-structure itself, which may absorb and/or relieve mechanical stress, in particular, longitudinal mechanical stress. The ability to absorb or relieve mechanical stress may be affected by the height and thickness of the pad. For example, the flexibility is increased compared to a flat design, for example, a flat connection (e.g., a flat pad) between the flexible interconnect and the busbar.

According to one embodiment of the present disclosure, a first gap may be formed between the flexible interconnect and the first part of the pad. The first gap is measured from a top surface of the first part of the pad facing the flexible interconnect to a lower surface of the flexible interconnect facing the first part of the pad. The height of the first gap is larger than the material thickness of the first part of the pad. This height may improve the flexibility of the pad and overall reliability.

According to another embodiment of the present disclosure, a second gap may be formed between the flexible interconnect and the busbar. The second gap is measured from a top surface of the busbar facing the flexible interconnect and a lower surface of the flexible interconnect facing the busbar. The height of the second gap may be larger than the sum of the material thicknesses of the first and second parts of the pad. This height may improve the flexibility of the pad and overall reliability.

The first gap and/or the second gap may be in a range of about 0.5 mm to about 3 mm, a range of about 0.8 mm to about 2 mm, or in a range of about 1.5 mm to about 1.8 mm. These ranges provide a good compromise between a compact design while providing improved safety and reliability, as discussed above. If the gap(s) is more than about 0.8 mm, reliability can be improved considerably, and if the gap(s) is about 2 mm, very good flexibility is provided. In some embodiments, the gap(s) may not be constant. Then, the values may refer to the maximum value of the respective gap(s) and the minimum values may refer to the minimum values of the above ranges.

According to one embodiment, the busbar may be below (or under) the first part of the pad and on top of (or above) the battery cells and/or the flexible interconnect is on top of (or above) the second part of the pad.

In some embodiments, the first part is directly connected to the busbar. This enables precise positioning of the pad and the flexible interconnect. Positioning accuracy is beneficial for automated and, therefore, convenient assembly.

In another embodiment, the first part may be welded to the busbar. Welding is quick and precise and suitable for connecting a busbar with a conductive pad. The pad may be made of nickel (Ni) but is not limited thereto. The pad may have a material thickness in a range of about 0.2 mm to about 1 mm, in a range of about 0.3 mm to about 0.8 mm, or in a range of about 0.4 mm to about 0.6 mm and/or a width in a range of about 0.5 mm to about 3 mm, in a range of about 0.6 mm to about 2 mm, or in a range of about 0.7 mm to about 1.5 mm. A thickness of greater than about 0.2 mm provides sufficient strength and very good flexibility. A thickness of about 1 mm provides very good strength and sufficient flexibility. A larger width of the pad allows for easier assembly, with larger tolerances for welding.

In some embodiments, the second part is directly connected to the flexible interconnect. This enables precise positioning of the pad and the flexible interconnect. Positioning accuracy is beneficial for automated and, therefore, convenient assembly.

According to another embodiment, the second part may be soldered to the flexible interconnect. Soldering is suitable for thin conductor lines or signal lines for transporting (or transmitting) electrical information along the flexible interconnect to a BMU.

Yet another embodiment relates to the pad being non-planar. A non-planar pad provides a spacing that is larger than the thickness of the material alone. This saves material compared to a solid pad providing the same spacing. Additionally, the pad is flexible.

According to one embodiment of the present disclosure, the first part and/or the second part may be planar. A planar surface of these parts increases the contact surface. It also reduces the contact resistance. Furthermore, a flat second part provides mechanical support for the flexible interconnect. A flat first part provides support for the pad together with the flexible interconnect.

In some embodiments, the flexible interconnect, the pad, and the busbar may be arranged in parallel to each other. This allows for easier manufacturing. Additionally, automatic placement is possible. The flexible interconnect, the pad, and the busbar may be horizontally stacked layered structures, for example, they may be directly stacked on top of each other, respectively. This ensures a compact design with minimal space requirements.

In one embodiment, the third part extends in a plane perpendicular to the first plane and the second plane. This allows for relatively large spacing while using minimal material. Further, a right angle is easy to form. Additionally, this shape enables maximum support in vertical direction so that, in some embodiments, only one third part may be sufficient.

In one embodiment, the third part extends in a plane tilted with respect to a plane perpendicular to the first plane and second plane. The tilted arrangement allows for a spring-like behavior. This benefits stress-release and stress-absorption capabilities in horizontal and vertical direction.

In some embodiments, the pad has a Z-shape, a U-shape, or an Ω-shape. In the Z-shape embodiment, the lower straight leg corresponds to the first part, the upper straight portion parallel to the lower straight leg corresponds to the second part, and the oblique portion between the lower straight leg and the upper straight portion corresponds to the third part. The Z-shape pad provides particularly good elasticity in vertical direction. In some embodiments, the projection of the first part and the second part may overlap such that their size and positioning are identical with the only difference being that they are in parallel but different planes. This arrangement provides a compact footprint and is suitable for compact embodiments.

In the U-shape embodiment, the lower straight portion or bottom corresponds to the first part, the two straight upright portions on the sides correspond to two third parts, and the second parts extend, parallel to the first part, from the upper ends of the two straight upright portions away from the first part. The U-shape embodiment exhibits particularly good flexibility in horizontal direction.

In the Ω-shape embodiment, the two lower legs correspond to two second parts, the part of the middle portion of the Ω-shape that has a tangent is parallel to the two lower legs and forms the first part, which may be flat instead of round, and the two sections between the first part and the two second parts form the two third parts. The Ω-shape embodiment provides particularly good elasticity in vertical and horizontal direction.

In one embodiment, the first part may be between the two second parts, and the two third parts may be between the respective second part and the first part. The two second parts provide support for the flexible interconnect, and the two third parts provide support in vertical direction. This structure is resilient to external stress, in particular, longitudinal stress.

In another embodiment, the second part may be, in its plane and on its free end, recessed such that two fingers with the recess therebetween. The recess is suitable for accommodating solder or excess solder. In other words, the solder is held in place. Additionally, the amount of solder becomes more consistent, and the placement of the flexible interconnect becomes more convenient. Furthermore, because the solder connection is more consistent, the contact resistance is more consistent. Therefore, the electrical information is also more consistent and reliable.

In one embodiment, the flexible interconnect may be formed as a flexible printed circuit (FPC). A flexible interconnect is relatively easy to design, manufacture, handle, and place because it may include a plurality of electrical lines or signal lines isolated from each other.

In one embodiment, the flexible interconnect may be electrically connected to multiple busbars while the busbars remain electrically isolated from each other. This arrangement enables the use of only one flexible interconnect to access the electrical information of any arbitrary number of battery cells in the battery module by only a few, (e.g., one or two) flexible interconnects.

Further, the flexible interconnect may have a cutout at where a first plane of the flexible interconnect overlaps with a second plane, intersecting with the pad and parallel to the first plane, in vertical direction of the plane, except where the pad is connected to the flexible interconnect. In some embodiments, the cutout is smaller, for example, equivalent to the area in which the first part of the pad overlaps with the flexible interconnect. The first portion of the pad may be welded to the busbar through this cutout.

According to another embodiment of the present disclosure, the battery pack described above may be used in electric vehicles.

The pad may be produced by a punching process. Punching is a quick and easy manufacturing method with high throughput and consistency. For example, the shape of the pad may be such that it can be formed or produced by a punching process. Thereby, the pad can be economically produced and may be weldable, in particular, the first part may be weldable, and solderable by accommodating the solder such that the solder joint is consistently formed on the second part while providing not only flexibility, in particular in a longitudinal direction, but also connecting the flexible interconnect with the busbar.

Further aspects and features of the present disclosure may be learned from the following description and the claims.

### BRIEF DESCRIPTION OF THE DRAWINGS

Aspects and features of the present disclosure will become apparent to those of ordinary skill in the art by describing, in detail, embodiments thereof with reference to the attached drawings, in which:

FIG. 1 is a partial perspective view of a battery module according to the related art.

FIG. 2 is a partial perspective view of a flexible interconnect according to the related art.

FIG. 3 is a schematic cross-sectional view of an interconnect-structure according to the related art.

FIG. 4 is a cross-sectional view of a pad according to an embodiment of the present disclosure.

FIG. 5 is a schematic cross-sectional view of a busbar and a flexible interconnect connected by a pad according to an embodiment of the present disclosure.

FIG. 6 is a schematic cross-sectional view of a busbar and a flexible interconnect connected by a pad according to another embodiment of the present disclosure.

FIG. 7 is a schematic cross section of a busbar and a flexible interconnect connected by a pad according to another embodiment of the present disclosure.

FIG. 8 is a top view of a pad according to an embodiment of the present disclosure.

### DETAILED DESCRIPTION

Reference will now be made, in detail, to embodiments illustrated in the accompanying drawings. Aspects and features of the present disclosure, and implementation methods thereof, will be described with reference to the accompanying drawings. The present disclosure may, however, be embodied in various different forms and should not be construed as being limited to the embodiments illustrated herein. Rather, these embodiments are provided as examples so that this disclosure will be thorough and complete and will fully convey the aspects and features of the present disclosure to those skilled in the art.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

The electrical connections or interconnections described herein may be realized by conducting elements, for example, on (e.g., formed on) a PCB or another kind of circuit carrier. The conducting elements may include metallization, such as surface metallizations and/or pins, and/or may include conductive polymers or ceramics.

According to one embodiment of the present disclosure, a battery module includes a plurality of battery cells, a busbar for electrically connecting the plurality of battery cells, a flexible interconnect for providing electrical information of the battery cells to a battery management system, and a conductive pad between the flexible interconnect and the busbar. The pad, according to an embodiment, includes a first part extending in a first plane, at least one second part extending in a second plane parallel to the first plane and spaced apart from the first part in a direction perpendicular to the first and second planes, and at least one third part connecting the first part with each of the at least one second part. The parts are related in that the first part extends from the third part in a direction opposite the direction the second part extends from the third part. Further, the busbar is attached to the first part of the pad, and the flexible interconnect is attached to the second part of the pad.

The pad spaces (e.g., acts as a spacer between) the busbar from the flexible interconnect by have a defined shape. For example, the pad has a non-flat or non-planar shape such that the distance between the busbar and the flexible interconnect will be greater than in the related art, which employs flat pads, thereby limiting the spacing to the material thickness of the pad. Due to the increased spacing according to embodiments of the present disclosure, reliability is increased because the risk of short-circuits is reduced. However, other aspects and features may be obtained. For example, due to the larger distance between the flexible interconnect and the busbar, the surface quality of the busbar can be more rough (e.g., less processed) so that time and power-consuming additional processing steps can be omitted. Further, according to embodiments of the present disclosure, the spacing of the first part from the second part provides increased mechanical flexibility.

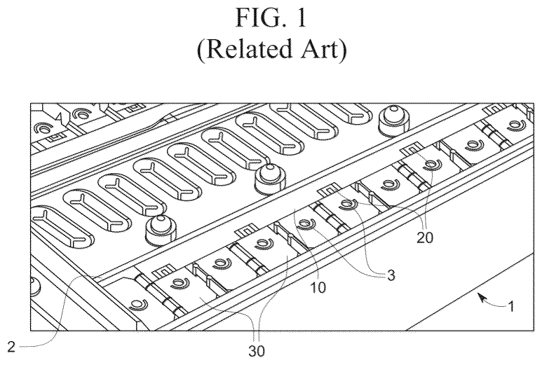

FIG. 1 illustrates a battery module 1 according to the related art. FIG. 1 is a partial perspective view of an upper surface of the battery module 1 in which a plurality of battery cells 2 are arranged in parallel along a longitudinal direction of the battery module 1. The plurality of battery cells 2 are connected to each other by busbars 30. The busbar 30 connects terminals 3 of the battery cells 2. Two neighboring battery cells 2 are connected by one busbar 30. The busbar 30 extends along the stacking (or alignment) direction of the battery cells 2 and are on top of and parallel to the stacking direction of the battery cells 2. In the battery module 1 shown in FIG. 1, the busbar 30 has a planar structure. A pad 20 is arranged on top of the busbar 30 and is connected to a flexible interconnect 10. The flexible interconnect 10 extends along the battery module 1 in the longitudinal direction. Referring to FIG. 1, six busbars 30, each having one pad 20 thereof, are all connected to the same flexible interconnect 10. Thus, in turn, the flexible interconnect 10 has at least six signal lines. In this case, the number of signal lines formed on (or in) the flexible interconnect 10 is equal to the number of busbars 30 connected to the flexible interconnect 10.

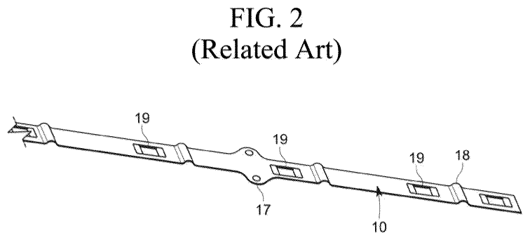

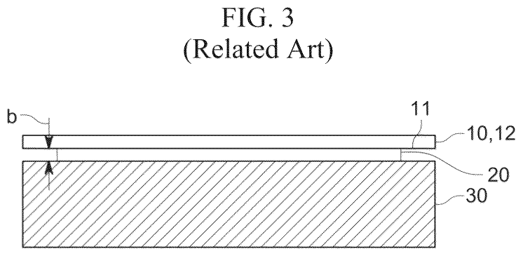

FIGS. 2 and 3 illustrate battery cell contacting structures according to the related art FIG. 2 illustrates one non-limiting example of a flexible interconnect 10 and an FPC 12 according to the related art. Pad-portions 19 may be cut-out such that flat pads, to be connected to busbars 30, can be soldered to the bottom of the flexible interconnect 10 at the locations of the pad-portions 19. Further, the flexible interconnect 10 may have mounting holes 17 on its sides with a margin for adjustment when placing the flexible interconnect 10. The signal lines for transferring the electrical information of the battery cells 2 to a battery management system are located on the bottom of the flexible interconnect 10. The signal lines may be coated with an isolation layer 11. However, the isolation layer 11 can be damaged when not handled accurately, for example, during manual or automated installation by gratings or burrs or sharp edges or other damage on the surface of the busbar 30 facing the flexible interconnect 10. Additionally, the flat pads have insufficient flexibility in longitudinal direction and cannot absorb stress.

FIG. 3 is a cross-sectional view illustrating a connection of a flexible interconnect 10 to a busbar 30 by a pad 20 according to the related art. The busbar 30 is provided for electrically connecting a plurality of battery cells. The busbar 30 is, on its lower side, connected to one or more battery cell terminals and, on its upper side, is connected to the pad 20. The pad 20 is, on its upper side, connected to the flexible interconnect 10, which may be implemented as a flexible printed circuit (FPC) 12. The flexible interconnect 10 is configured to provide electrical information of the battery cells 2 to a battery management system. The pad 20 is conductive and is provided between the flexible interconnect 10 and the busbar 30. The pad 20 may also be referred to herein as the conductive pad 20. The pad 20 is sandwiched between the busbar 30 and the flexible interconnect 10.

As can be seen in FIG. 3, the distance b between the busbar 30 and the flexible interconnect 10 is equivalent to the thickness of the material of the pad 20. In other words, the pad 20 has a flat shape (e.g., the pad 20 lies flat on or is in complete surface contact with the busbar 30). Referring to FIGS. 1 to 3, the busbar 30, the pad 20, and the flexible interconnect 10 are stacked on top of each other parallel to the top surface of the battery cells 2. Each of these elements extends in a two-dimensional plane parallel to the top of the battery cells 2.

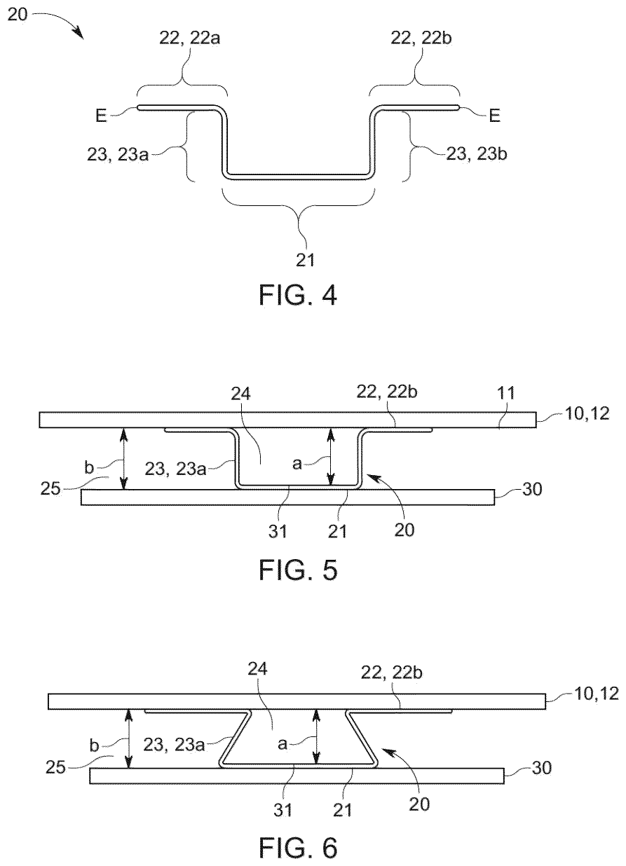

FIG. 4 is a vertical cut through (or cross-sectional view) of a pad 20 according to an embodiment of the present disclosure, and FIG. 5 is a vertical cut through of structure including a busbar 30, the pad 20 (as shown in, for example, FIG. 4), and a flexible interconnect 10 according to an embodiment of the present disclosure. Referring to FIG. 4, the pad 20 has a U-shape but is not limited thereto. The pad 20 has a first part (e.g., a base) 21 extending in a first plane (a horizontal plane in the illustrated embodiment), at least one second part (e.g., at least one distal part) 22 extending in a second plane (also a horizontal plane in the illustrated embodiment) parallel to the first plane and spaced apart from the first part 21 in a direction perpendicular to the first and second planes, and at least one third part (e.g., connecting part) 23 connecting the first part 21 with the corresponding at least one second part 22. Further, the first part 21 extends from the third part 23 in a direction opposite the direction the at least one second part 22 extends from the third part 23. In some embodiments, the third part 23 extends in a plane perpendicular to the first plane and the second plane. In the illustrated embodiment, the pad 20 has a U-shape. However, even though the corners between the first part 21 and the third part 23 and/or the corners between the third part 23 and the second part 22 are illustrated as being rounded, they are not limited thereto. In various embodiments, the corners may be 90° or rounded or any shape in between. The U-shape may include perpendicular straight lines, for example, each of the first, second, and third parts 21, 22, 23 may include a straight line such that the third part 23 is perpendicular to the first and second parts 21, 22. The second part(s) 22 are formed to extend along a stacking direction of the battery cells or along a direction between terminals of different battery cells. The second part(s) 22 may be planar such that the interconnect 10 can be placed and supported by the planar second parts 22. Two second parts 22 may be provided and spaced apart from each other in the horizontal direction such that a gap 24 is formed between the center of the pad 20, the first part 21, and the interconnect 10. The planar shape of the second part(s) 22 improves the contact area between the second part(s) 22 and the interconnect 10 and improves assembly. Also, the first part 21 may be planar, at least on its lower surface, such that the contact between the busbar 30 and the pad 20 is improved.

The pad 20 forms a gap 24, that is, a spacing in vertical direction, between the interconnect 10 and the first part 21 of the pad 20, have a distance a between the planes of the first part 21 and the second part 22 formed by the vertical extending connecting structure of the third parts 23. The pad 20 has a structure such that its upper part, that is, the second part 22, is spaced apart from its lower part, that is, the first part 21. The pad 20, according to an embodiment, may have an integral structure formed by punching (or stamping) a flat sheet into a corresponding three-dimensional shape.

In the illustrated embodiment, one first part 21 is connected to two second parts 22a, 22b by two third parts 23a, 23b. The leftmost second part 22a extends from the upper end of the leftmost third part 23a towards the left. The first part 21 extends from the lower end of the leftmost third part 23a towards the right and contacts the rightmost third part 23b on its lower end. The rightmost second part 22b extends from the upper end of the rightmost third part 23b towards the right. In this way, a three-dimensional pad structure is formed, and in the illustrated embodiment, a U-shaped pad structure is formed. The pad 20 may have a rectangular structure or a bowl-like structure.

FIG. 5 is a vertical cut through (or a cross-sectional view) of a battery cell contact structure according to an embodiment. Referring to FIG. 5, the pad 20 shown in FIG. 4 is arranged between a busbar 30 and an interconnect 10. The lower surface of the first part 21 of the pad 20 electrically contacts (e.g., is electrically connected to) the upper side of the busbar 30. The upper surfaces of the second parts 22 of the pad 20 electrically contact (e.g., are electrically connected to) the lower surface of the interconnect 10. The pad 20 may have a U-shape but is not limited thereto. The first part 21 and the second part 22 may be planar. This shape of the pad 20 is characterized in that the busbar 30 is attached to the first part 21 of the pad 20 and the flexible interconnect 10 is attached to the at least one second part 22 of the pad 20. The first part 21 may be welded to the busbar 30, for example, at a welding spot 31. The welding spot 31 may be located in the middle of the first part 21. In this case, the welding spot 31 can be accessed conveniently from the top. However, welding from the side is also an option, for example, when the welding spot 31 is not located in the middle, depending on the manufacturing process as a whole. Also, a plurality of welding spots 31 may be formed, for example, at the ends of the first part 21. In some embodiments, the connections between the first part 21 and the second part 22 can be direct or through additional connection enhancing intermediate layers. Similarly, the second part 22 may be soldered to the flexible interconnect 10 (e.g., to the FPC 12). In the illustrated embodiment, two second parts 22 are connected to the flexible interconnect 10. The first part 21 forms the bottom of the pad 20 and the two third parts 23 form the upright side-portions of the pad 20, and the two second parts 22 extend from the upper ends of the third parts 23. The second parts 22 are connected to the flexible interconnect 10 and establish an electrical connection between the flexible interconnect 10 and the pad 20. Similarly, the first part 21 is connected to the busbar 30 and establishes an electrical connection between the busbar 30 and the pad 20. The third part 23 connects the first part 21 and the second part 23, and thereby connects (e.g., electrically connects) the busbar 30 with the flexible interconnect 10 through the pad 20.

The pad 20 can be located at any suitable position between the flexible interconnect 10 and the busbar 30. For example, the pad 20 could be moved horizontally to any suitable position. When the pad 20 is placed as shown in FIG. 5, a first gap 24 having the distance a from the upper side of the first part 21 to the lower side of the flexible interconnect 10 is formed. The distance a of the first gap 24 is larger than the material thickness of the second part 22 of the pad 20. Additionally, a second gap 25 is formed between the flexible interconnect 10 and the busbar 30 spanning a distance b. The distance b of the second gap 25 is larger than the sum of the material thicknesses of the first part 21 and the second part 22 of the pad 20. In this embodiment, the distance b is equal to the distance a plus the thickness of part 21 of the pad 20.

Compared to FIG. 3, according to embodiments of the present disclosure, the distance b between the interconnect 10 and the busbar 30 is increased by several multiples of the material thickness of the pad 20.

The flexible interconnect 10 is provided with (or includes) signal lines on its surface facing the pad 20 for connection with the pad 20 to transfer electrical information through the line to a BMU/BMS. One flexible interconnect 10 may connect multiple pads 20 with multiple signal lines. Those signal lines are covered by an isolation layer 11 to prevent short circuits between different lines. The isolation 11 may be a polyimide (PI) coating layer, which may be several tenths of micrometer thick. A thickness in a range of more than about 10 μm and at most about 100 μm would be sufficient for most conditions. Therefore, a suitable range for a thickness of the isolation 11 is in a range of about 10 to about 100 μm, for example, in a range of about 30 to about 80 μm or in a range of about 40 to about 65 μm. If the isolation is breached by sharp edges, such as those from welding spots, or preceding production processes of the pad 20, such as a burr formed during punching, a short circuit may occur between normally unconnected busbars 30 and—if accidentally connected—lead to a short circuit and corresponding high currents, which may lead to the destruction of certain parts of the circuit and which could damage or destroy the whole battery module 1 or pack.

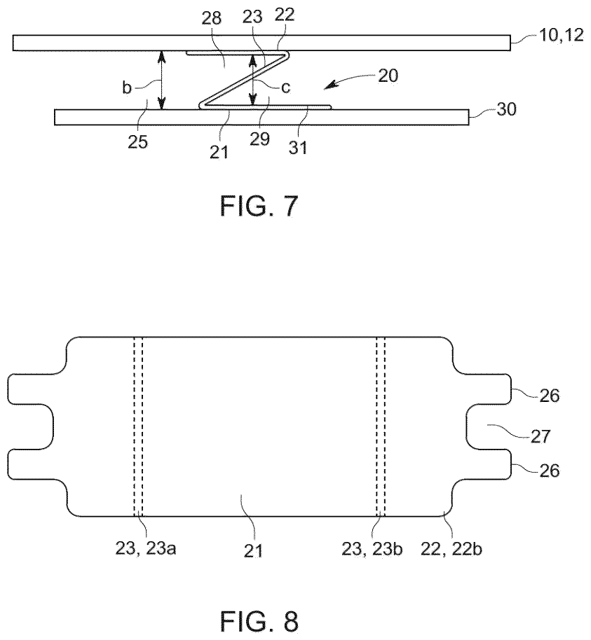

FIGS. 6 and 7 are cross-sectional views illustrating two other embodiments of the pad 20. FIG. 6 shows an Q-like shaped pad 20, which is similar to the U-shaped pad 20 except that the third part(s) 23 may be angled, tilted, oblique, or rounded. An angled, tilted, or rounded shape provides additional flexibility to the pad 20. In the illustrated orientation, the shape of the pad 20 may be referred to as an upside-down Ω-like shape. In this embodiment, the upper portion of the Ω-shape corresponds to a first part 21, which may be flat. The two third portions 23 are angled or tilted towards the vertical direction, in particular, are angled in opposite directions. While an angle (e.g., a non-right angle) is formed between the first part 21 and the third part 23, the transition between both parts may be rounded. Due to the angled, tilted, or oblique arrangement of the third part 23, the first part 21 and the second part 22 at least partially overlap in the vertical direction. The amount of overlap is determined by the inclination angle of the third part 23. Thereby, the pad 20 may be made more compact compared to the embodiment shown in FIGS. 4 and 5. Further, the angle determines the flexibility in horizontal and vertical direction, which is further discussed below.

FIG. 7 shows a Z-shaped pad 20. In this embodiment, the pad 20 may include only one second part 22 connected by one third part 23. In this embodiment, the third part 23 is angled or formed to extend in a plane tilted with respect to a plane perpendicular to the first plane and second plane. In some embodiments, the first part 21 might be slightly longer than the second part 22. Thereby, a welding spot 31 accessible from the top might be provided. However, in other embodiments, the first part 21 and the second part 22 may have the same length to provide a more compact design. In this embodiment, a third gap 28 between the second part 22 and the third part 23, and a fourth gap 29 between the third part 23 and the first part 21 may be formed. The third gap 28 and the fourth gap 29 may have a triangular shape, at least in the region of the third part 23. In this embodiment, the distance between the flexible interconnect 10 and the busbar 30 is, in a direction normal to the plane of the first part 21 and/or second part 22, or in the direction of arrow b, from bottom to top—the sum of the thickness of the first part 21, the height of the fourth gap 29, the height of the third part 23 along the normal, the height of the third gap 28, and the thickness of the second part 22.

When comparing the embodiments shown in FIGS. 5 to 7, the third part 23 in FIG. 5 is formed in a straight line to connect the first part 21 and the second part 22 in the shortest possible distance. This allows for strong support in the vertical direction. Additionally, the pad 20 is flexible in the horizontal direction. The embodiments shown in FIGS. 5 and 6 forms one first gap 24 between the flexible interconnect 10 and the first part 21. The distance b of the second gap 25 may be identical and may not be directly influenced by the shape of the pad 20. For example, the shape of the pad 20 can be adapted or modified to provide the desired or targeted distance b of the second gap 25. The third parts 23 in the embodiments shown in FIGS. 6 and 7 are angled towards the vertical direction. By altering the angle, the elasticity of the pad 20 can be adjusted in horizontal and vertical direction. For example, when the third part 23 is more upright, flexibility in horizontal direction is improved. When the third part 23 is less upright, flexibility in vertical direction is improved. Further, by altering the number of third parts 23, the amount of support and/or the size of the footprint of the pad 20 can be adjusted.

However, it should be understood that many other shapes can achieve the same functionality, that is, the pad 20 is not limited to the shapes disclosed in FIG. 5-7. For example, a U-shaped pad 20 may be cut in half vertically in the middle of the first part 21 and would still form a gap between the busbar 30 and the flexible interconnect 10. In some embodiments, the pad 20 may be non-planar. In some embodiments, the first part 21 and/or the second part 22 may not be flat or planar but can have any suitable shape, such as rounded, zigzag, triangle, step-like, trapezoidal shapes, and so on. For example, the first part 21 may have a suitable shape for welding it to the busbar 30. Similarly, the second part 22 may have a suitable shape for soldering it to the flexible interconnect 10. The third part 23 is enclosed or exists in between the first part 21 and the second part 22 or the second parts 22 when seen from one open-end E of the pad 20 to another open-end E of the pad 20. The pad 20 may be formed from one piece (e.g., may be integrally formed). The same structure of the pad 20 may be implemented for any arrangement of other cell types, such as cylindrical cells. Because cylindrical battery cells have poles on opposite ends, the busbar, the flexible interconnect, and the pad may be provided on both ends, respectively. Furthermore, if a step exists on the battery cell, on the busbar, or on the interconnect, the pad structure may be adapted to such structure such that first instance the lower part 21 is divided in two parts extending in different planes or such that one third part 23 may be longer than the other third part 23. Thereby, the second parts 21 extend in different but parallel planes.

FIG. 8 is a top view of a U-shaped pad 20. The pad 20 includes a first part 21, two second parts 22, and two third parts 23 between the first part 21 and the second part 22. In the illustrated embodiment, the second part 22 may be formed as a flange, which may have at least one finger 26 and a recess 27 in its plane and on its free end, respectively. The recess 27 may accommodate solder for soldering the pad 20 to the flexible interconnect 10. The recess 27 has allows the solder to be concentrated in a defined location during soldering. For example, the recess restricts the flow of the solder and may accommodate different volumes of solder. Different volumes of solder may be the result of tolerances of a solder dispenser. Therefore, the recess 27 ensures a consisting soldering connection.

According to embodiments of the present disclosure, automated placement of the flexible interconnect is possible due to the relaxed placement requirements, the reduced short circuit risk, and the ability to optically confirm the proper placement of the flexible interconnect.

Additionally, the elevated placement of the flexible interconnect over the busbar introduces a new level of flexibility into the battery module. Even though the battery cells may swell due to aging or electrical stress, the cells still remain electrically functional. Therefore, flexibility of the internal wiring connections prevents mechanical stress on the cell terminals and the interconnect structure. In other words, if mechanical stress caused by swelling of cells leads to mechanical stress on internal electrical contacts, the contacts are likely to degrade and may fail. Even if only one connection between the flexible interconnect and the busbar fails, this may cause a battery module failure because, when the cell potential cannot be monitored by the EMU/BMS, then the entire module is likely to be shut down for safety reasons. In other words, flexibility of the interconnect system increases reliability on the whole battery module.

Some Reference Symbols

| | | | |
|---|---|---|---|
| 1 | battery module | 2 | battery cell |
| 3 | terminal | 10 | flexible interconnect |
| 11 | isolation layer | 12 | flexible printed circuit |
| 17 | mounting hole | 18 | stress relieve portion |
| 19 | pad-portion | 20 | pad |
| 21 | first part | 22 | second part |
| 22a | leftmost second part | 22b | rightmost second part |
| 23 | third part | 23a | leftmost third part |
| 23b | rightmost third part | 24 | first gap |
| 25 | second gap | 26 | fingers |
| 27 | recess | 28 | third gap |
| 29 | fourth gap | 30 | busbar |
| 31 | welding spot | | |

What is claimed is:

1. A battery module comprising:
a plurality of battery cells;
a busbar electrically connecting the battery cells to each other;
a flexible interconnect configured to provide electrical information of the battery cells to a battery management system; and
a conductive pad between the flexible interconnect and the busbar, the conductive pad comprising:
a first part extending in a first plane;
a second part extending in a second plane parallel to the first plane and spaced apart from the first part in a direction perpendicular to the first and second planes; and
a third part connecting the first part and second part,
wherein the first part extends from the third part in a direction opposite the direction the second part extends from the third part,
wherein the busbar is attached to the first part of the conductive pad, and
wherein the flexible interconnect is attached to the second part of the conductive pad.

2. The battery module as claimed in claim 1, wherein a first gap is formed between the flexible interconnect and the first part of the conductive pad, and
wherein a height of the first gap is larger than a material thickness of the first part of the conductive pad.

3. The battery module as claimed in claim 1, wherein a second gap is formed between the flexible interconnect and the busbar, and
wherein a height of the second gap is larger than a sum of material thicknesses of the first part and the second part of the conductive pad.

4. The battery module as claimed in claim 1, wherein the busbar is below the first part of the conductive pad and is above the battery cells.

5. The battery module as claimed in claim 1, wherein the flexible interconnect is above the second part of the conductive pad.

6. The battery module as claimed in claim 1, wherein the first part is directly connected to the busbar.

7. The battery module as claimed in claim 1, wherein the first part is welded to the busbar.

8. The battery module as claimed in claim 1, wherein the second part is directly connected to the flexible interconnect.

9. The battery module as claimed in claim 1, wherein the second part is soldered to the flexible interconnect.

10. The battery module as claimed in claim 1, wherein the conductive pad is non-planar.

11. The battery module as claimed in claim 1, wherein at least one of the first part and the second part is planar.

12. The battery module as claimed in claim 1, wherein the third part extends in a plane perpendicular to the first plane and the second plane.

13. The battery module as claimed in claim 1, wherein the third part extends in a plane tilted with respect to a plane perpendicular to the first plane and the second plane.

14. The battery module as claimed in claim 1, wherein the conductive pad has a U-shape, an Ω-shape, or a Z-shape.

15. The battery module as claimed in claim 1, wherein the conductive pad comprises two of the second parts and two of the third parts,
wherein the first part is between the two second parts, and
wherein the two third parts are between the respective second part and the first part.

16. The battery module as claimed in claim 1, wherein the second part has, in its plane and on its free end, a recess between two fingers.
